(19) United States
(12) Patent Application Publication
(10) Pub. No.: US 2010/0319630 A1
(43) Pub. Date: Dec. 23, 2010

(54) Apparatus for Rotating Livestock (Roll and Tac 360)

(76) Inventors: Brandon Treadway, Two Rivers, WI (US); David Van Boxtel, Oneida, WI (US)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/818,842

(22) Filed: Jun. 18, 2010

Related U.S. Application Data
(60) Provisional application No. 61/268,963, filed on Jun. 18, 2009.

(51) Int. Cl. A01K 15/04; A61D 3/00

(52) U.S. Cl. 119/724

(57) ABSTRACT

An apparatus for inverting a cow or other livestock from an upright, standing position through a full 360° angle rotation is provided.

### TECHNICAL FIELD

Embodiments of the invention relate to an apparatus for rotating an animal from a standing position through a full 360° angle rotation.

### BACKGROUND OF THE INVENTION

Cattle and other livestock are frequently processed or treated using a holding or confinement chute in which the animal is held in place. Most holding devices include a head gate composed of a yoke element that is fixed about the neck of the animal to prevent movement fore-and-aft, and many devices utilize adjustable side panels that mechanically squeeze the sides of the animal to hold it in place. Such devices can be useful for simple procedures such as hoof inspections, branding and injections, but surgical operations typically require an animal be laid out on an operating table or tilted surface to provide adequate access and orientation of the animal.

A serious problem that develops in cattle and other ruminants (e.g., goats, sheep, bison, etc.) that go off feed or have acidosis is the development of a displaced abomasum or “twisted stomach” whereby the abomasums (the last of four stomach chambers in ruminants) fills with gas, floats up out of place and becomes twisted, stopping the flow of digested food. A displaced abomasum can cause loss of appetite, decreased rumen contractions, decreased cud chewing, and a drop in milk production.

Typical treatment for a twisted stomach is surgery. Less common treatment is to roll the animal. In a surgical procedure, a veterinarian makes a small incision in the side of a cow to access the inflated swollen fourth stomach chamber, releases the gas in the section of stomach that has been blocked off, pulls the stomach section out to remove the twist and put it into its correct position, and then suture the section of stomach to the abdomen wall to prevent it from re-twisting. This and other procedures require adequate access to the side or belly of the animal to properly perform the procedure.

Efforts have been made to provide a chute device that could be mechanically rotated to place the animal on its side for a surgical procedure or rotated 180° or more from an upright position to a totally inverted position. However, the devices require the use of a head gate with an adjustable U-shaped bar which can result in injury to the animal's neck and head during rotation, and a squeezable chute to hold the animal in place which can cause harm to the animal. In addition, the devices are stationary, heavyweight constructions with complicated mechanisms and designs that are difficult and inconvenient to use.

It would be useful to provide a rotatable device for inverting livestock and other animals that overcomes these problems.

### BRIEF DESCRIPTION OF THE DRAWINGS

Embodiments of the invention are described below with reference to the following accompanying drawings, which are for illustrative purposes only. Throughout the following views, the reference numerals will be used in the drawings, and the same reference numerals will be used throughout the several views and in the description to indicate same or like parts.

FIGS. 1-2 illustrate perspective views of an embodiment of an apparatus according to the invention, showing the rear gate and the forward gate, respectively.

FIG. 3 is a front elevational view of the apparatus shown in FIGS. 1-2, showing the rear gate in FIG. 1 in a closed position, and an embodiment of a mechanically adjustable ceiling plate in an extended position.

FIG. 4 is a front elevational view of the apparatus of FIG. 1, showing the forward gate in FIG. 2 in a closed position, and the mechanically adjustable ceiling plate in a retracted position.

FIG. 5 is a plan view of the base of the apparatus of FIGS. 1-2, taken along lines 5-5 of FIG. 3.

FIG. 6 is a side elevation view of the connected rotatable inner circular frames of FIGS. 1-2. FIG. 6A is front elevational view of the circular frame shown in FIG. 6, taken along lines 6A-6A, showing the drive sprockets. FIG. 6B is a sectional view of the circular frame of FIG. 6. showing support brackets and a plate for mounting the ceiling panel. FIG. 6C is a plan view of a drive sprocket as shown in FIG. 6A.

FIG. 7 is a top plan view of the connected rotatable inner circular frames shown in FIG. 6, taken along lines 7-7, showing the ‘ceiling’ framework of the apparatus.

FIG. 8 is an elevational view of the rear gate shown in FIG. 3, in an open position.

FIG. 9 is an elevational view of one of the forward gates shown in FIG. 4.

FIG. 10 is a side elevational view of the apparatus of FIGS. 1-2, showing one of the side gates in a closed and locked position.

FIG. 11 is a side elevational view of the apparatus of FIGS. 1-2, showing the other of the side gates in a closed and locked position.

FIG. 12 is a side elevational view of the locking mechanism of the side gate shown in FIG. 11.

FIG. 13 is a plan view of an embodiment of a moveable ceiling panel of the apparatus depicted in FIGS. 1-2. FIG. 13A is a side elevational view of the ceiling panel of FIG. 13, taken along lines 13A-13A, showing the actuating arm in phantom. FIG. 13B is a front elevational view of the ceiling panel of FIG. 13, taken along lines 13B-13B.

FIG. 14 is a plan view of a connector of the moveable ceiling panel of FIG. 13.

FIGS. 15A-15B are plan views of front and back sides of an embodiment of a chain guard that can be utilized in the apparatus of FIGS. 1-2.

### DETAILED DESCRIPTION OF THE INVENTION

The following description with reference to the drawings provides illustrative examples of apparatus and methods according to embodiments of the invention. Such description is for illustrative purposes only and not for purposes of limiting the same.

The figures depict an embodiment of an apparatus for rotating an animal according to the invention.

The present invention provides an apparatus for inverting a cow or other livestock from an upright, standing position through a full 360° angle rotation. The apparatus fulfills the need for permitting ready access to all sides of a confined animal with a fraction of the physical effort required with other devices to perform procedures including, for example, hoof trimming and vaccinations, and surgical procedures such as to correct displaced abdomens, dehorning, castration, or other operations. The apparatus allows a cow or other animal to be fully inverted and is convenient, efficient and easy to operate and use. The sturdy construction provides the apparatus with a high level of strength and durability.

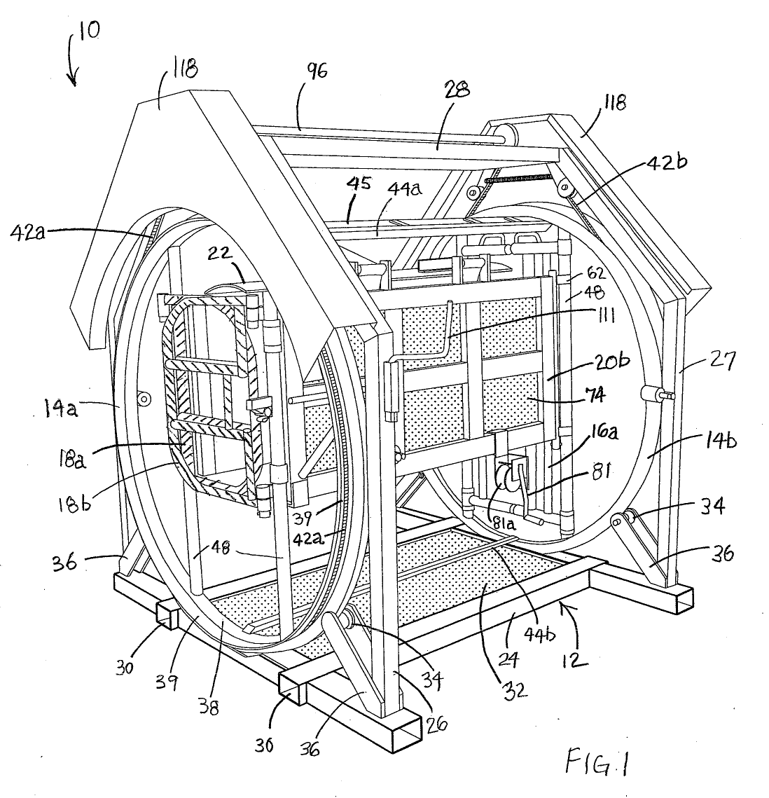

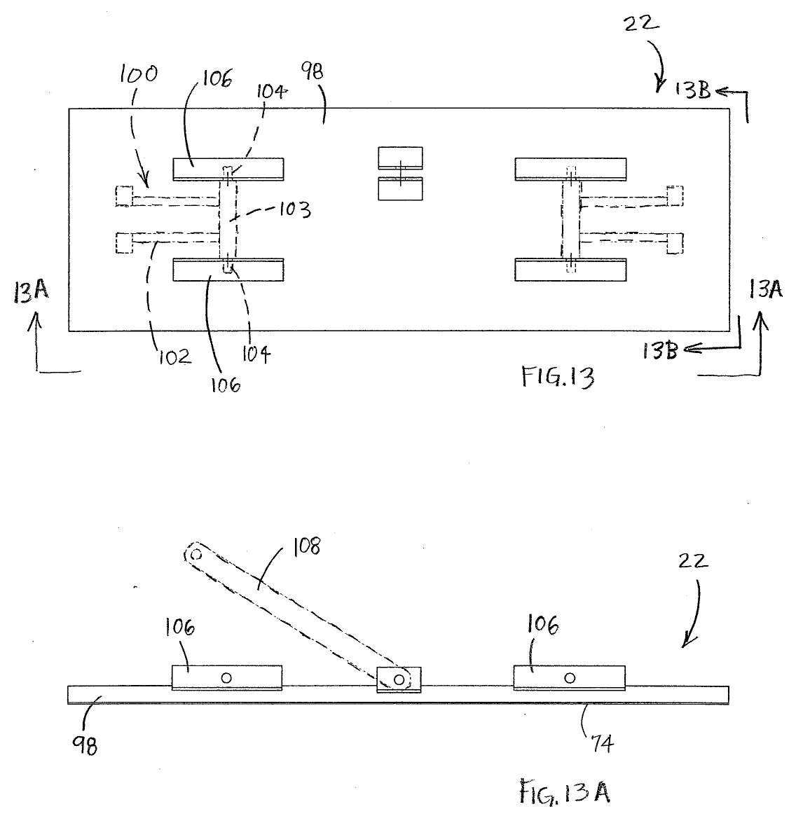

An embodiment of an apparatus 10 for rotating an animal according to the invention is illustrated and described with reference to FIGS. 1-15. The apparatus 10 is a cattle-chute type structure that is operable to rotate a cow or other livestock through a full 360 degree range of motion. The apparatus is composed of a stationary frame 12, a pair of rotatable inner circular frames 14a, 14b, a swinging forward gate 16a, 16b, swinging rear gate 18a, 18b, swinging side gates 20a, 20b, and a padded ceiling plate or panel 22.

The framework and gates of the apparatus can be fabricated of cut, drilled, formed, welded and painted rectangular, round or angled tubing/pipe, steel plate, and related stock materials. The rollers, hinges, chains, sprockets, bearings, motor and controls can be provided as standard items.

### Stationary Frame

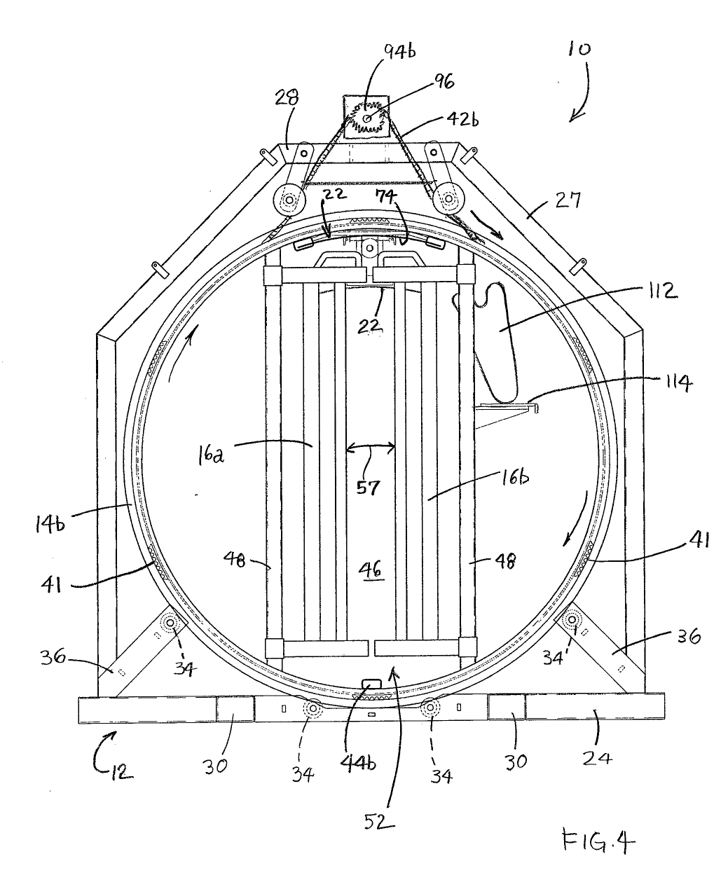

As illustrated in the figures, the stationary frame 12 includes a base frame 24 and a pair of outer supports 26, 28 at opposite ends of the base frame. A shown in FIG. 5, the base frame 24 is a rigid platform that can be constructed from rectangular steel tubing (e.g., about ¼″×4″×6″). The base frame 24 can include openings/notches 30 spaced apart for entry of fork-tines of a fork lift, typically being about 4″ in length, 1½″ in depth, for ready moving and transporting of the apparatus 10. A non-slip tread steel plate floor 32 (e.g., in diamond pattern) can be welded onto the base frame within the center of the frame.

The pair of outer supports 26, 28 can be structured, for example, from square tubing/pipe (e.g., ⅓″×3″×3″) to provide an angled frame such as depicted in FIGS. 1-4. In other embodiments, the outer supports can be circular-shaped and formed from square tubing cut at various lengths and degrees or from round tubing/pipe (e.g., 2⅞″).

The outer supports 26, 28 are spaced apart and the base of the supports is welded onto opposite ends of the base frame 24. As shown in FIGS. 1-4, one or more upper horizontal frame supports 27 can be welded at the upper section of the outer supports 26, 28 to connect and maintain the outer supports at equidistance. Although not shown, the base of the supports 26, 28 can be braced by brackets or upright corner supports mounted at the corners of the base frame 24.

The rotatable inner circular frames 14a, 14b are supported by industrial-grade track rollers (roller bearings) 34 (e.g., 3.25″ diameter, stainless steel) attached by bracket mounts 36 to the base frame 24 and the outer supports 26, 28, and within the base frame 24. In use, the track rollers 34 roll against and support the rotatable inner circular frames 14a, 14b.

### Inner Circular Frames

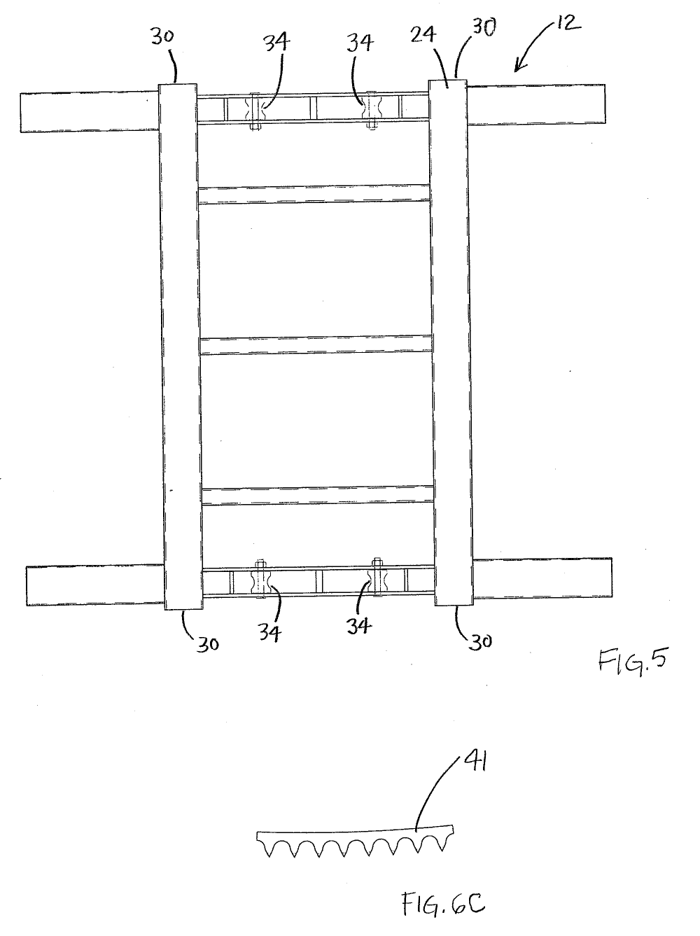

The rotatable inner circular frames 14a, 14b can be fabricated from a 2⅞″ round pipe that is formed and welded into a 360° circular framework section 38. As illustrated in side view in FIG. 6, a grooved circular frame section 39 can be mounted on the circular framework section 38 for supporting the drive chain (e.g., 42a). The grooved circular frame section 39 can be fabricated, for example, from a length of a flat steel stock (e.g., ¼″×3″) that can be rolled lengthwise along the edges to form a raised edge or lip 40 and welded to form a circular frame that can be mounted (e.g., welded) onto a side of the circular framework section 38 to provide a channel 40a (e.g., about 3″ wide) to receive the drive chain (e.g., 42a) therein.

A series of spaced apart gears or drive sprockets 41 (FIG. 6C) can be intermittently mounted (e.g., welded) on the grooved circular frame section 39 to engage the links of the drive chain (e.g., 42a), as illustrated in FIG. 6. In other embodiments, the drive sprockets 41 can be provided continuously about the grooved circular frame section 39.

As depicted in side view in FIG. 6, the rotatable inner circular frames 14a, 14b are connected by upper and lower spaced apart horizontal frame support brackets 44a, 44b. The horizontal frame support brackets 44a, 44b (e.g., ¼″×2″×4″ square tubes) can be welded at the base and at the top of the opposing rotatable inner circular frames 14a, 14b to connect and maintain the inner circular frames at equidistance.

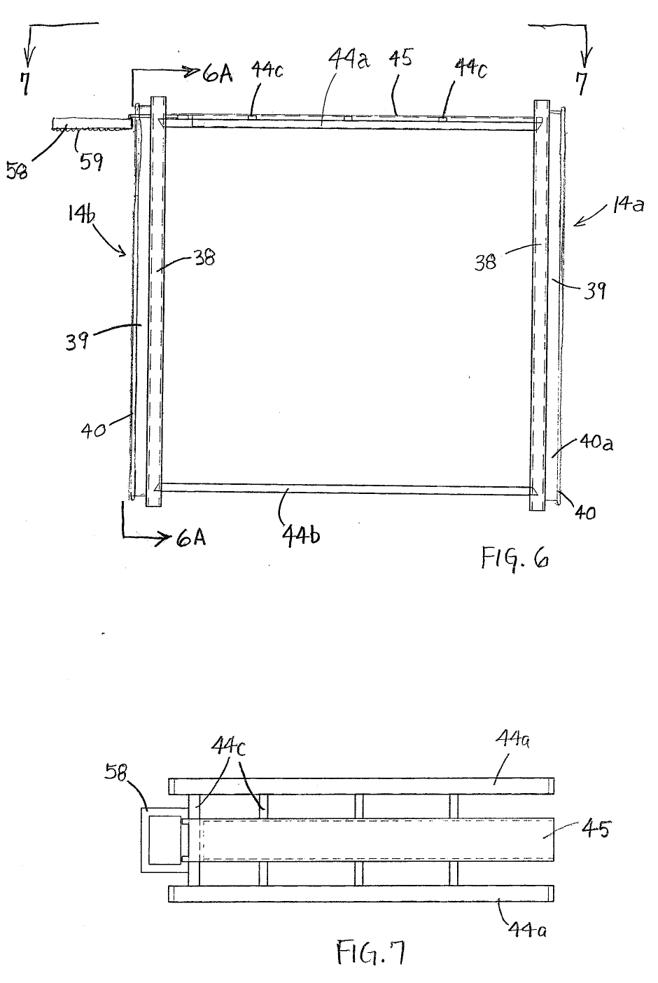

As shown in FIG. 7, support brackets 44c (e.g., ¼″×2″×4″ rectangular tubes) can be spaced apart and welded to support brackets 44a, to delineate a ‘ceiling’ framework for the interior chute enclosure 46. A channel plate 45 can be mounted, for example, onto the circular frame 14A, 14B, for mounting the moveable ceiling panel 22.

### Gates

The apparatus 10 includes a forward gate 16a, 16b, a rear gate 18a, 18b, and opposing side gates 20a, 20b, that allow access and loading and unloading of an animal into the interior chute enclosure 46 from any side of the apparatus.

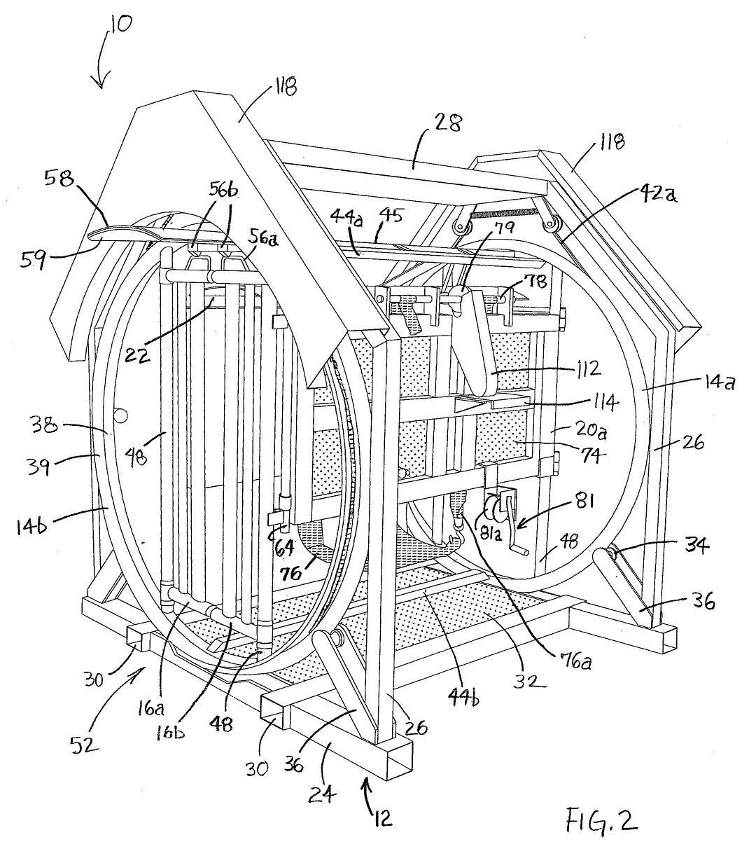

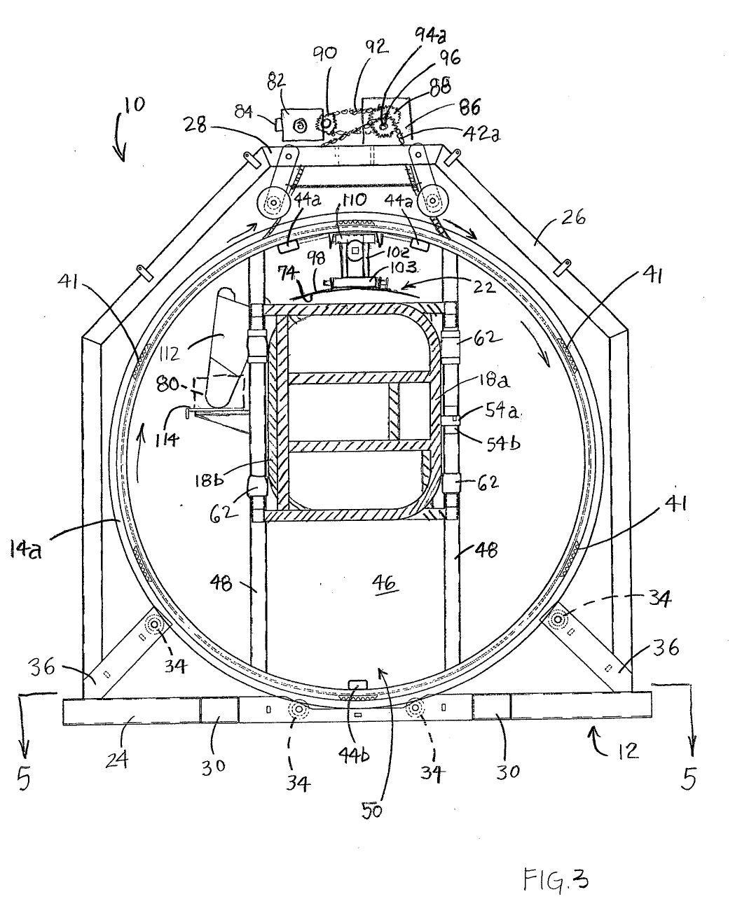

The forward gate 16a, 16b and rear gate 18a, 18b can be fabricated, for example, from 1⅝″ circular pipe. Referring to FIGS. 1-4 and 8-9, the forward and rear gates can be hinged to upright (vertical) poles 48 welded to an upper portion and a lower portion of the rotatable inner circular frames 14a, 14b and spaced apart to define the entryway 50 (FIG. 3) and exit (outlet) 52 (FIG. 4) of the chute enclosure 46. Additional supports (not shown) can be welded to the upright poles 48 and the inner circular frames 14a, 14b.

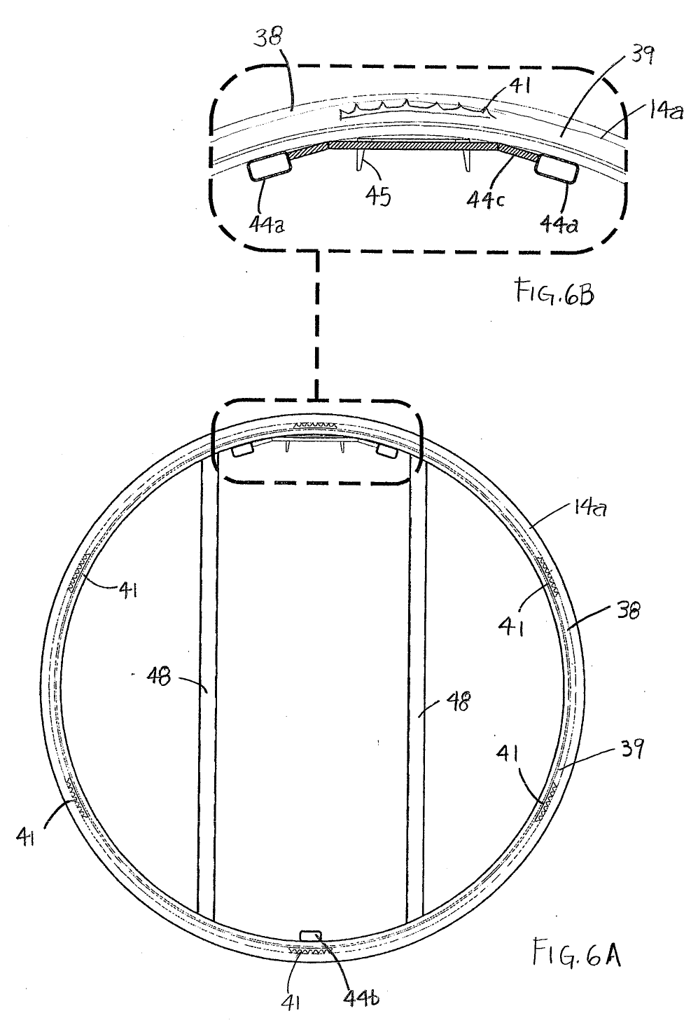

As illustrated, the rear gate 18 can be composed of a two-unit gate 18a, 18b in the form of café or saloon doors that are hinged to the upright poles 48 and swing inward and outward. The rear gate 18a can be locked with a door locking mechanism such as a slam lock gate latch in which an extension 54a (FIG. 8) on the gate 18a locks into a catch latch 54b (FIG. 3) mounted on the upright pole 48, or other suitable mechanism, which is preferably a quick-release locking mechanism. In another embodiment, the rear gate can be a single panel (or corral) gate that is hinged to one of the upright poles 48.

Referring to FIGS. 3-4 showing the rear view of the apparatus 10, the forward gate can be composed of a two-unit gate 16a, 16b in the form of café/saloon doors that are hinged to the upright poles 48 and can be swung inward and outward. The forward gate 16a, 16b can be structured and mounted such that, when the animal is loaded into the apparatus and runs into the forward gate units 16a, 16b (initially positioned inwardly in the chute enclosure 46), the contact of the ‘shoulders’ of the animal will force the gate 16a, 16b forwardly and into a locking mechanism, with the animal's neck and head positioned within and extending through a gap 57 between the forward gates 16a, 16b. The width (arrow) of the gap 57 is adequate to secure and confine the neck and head of the animal and restrain fore and aft movement.

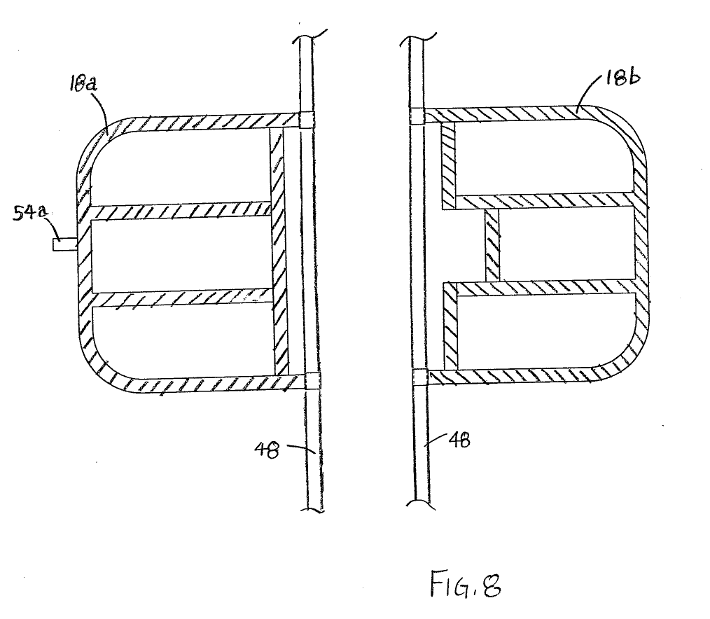

The locking mechanism for the forward gates 16a, 16b can be, for example, a catch latch in which a bar 56a (FIG. 9) mounted on each of the gate units is forced into a spring loaded catch lock 56b mounted on the bracket 44a (FIG. 2), to lock the forward gates in place. A release cable (not shown) attached to the catch locks 56b can be pulled to open the catch locks 56b and release the forward gates 16a, 16b.

As illustrated in FIGS. 2 and 7, a support plate 58, which can be curved, can be mounted on brackets 44a and padded 59 to support the head of the animal during use and rotation of the apparatus. A support plate (not shown) can also be mounted on the forward gate 16a (e.g., about 2′×2′ plate which is V-shaped, square, or other shape), being preferably removably mounted, to provide additional support to the head of the animal during rotation of the apparatus.

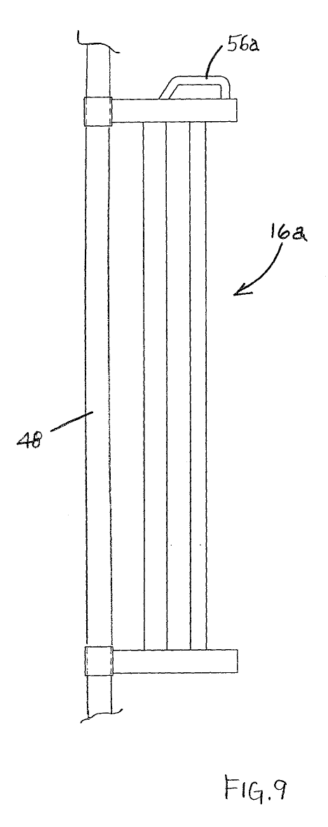

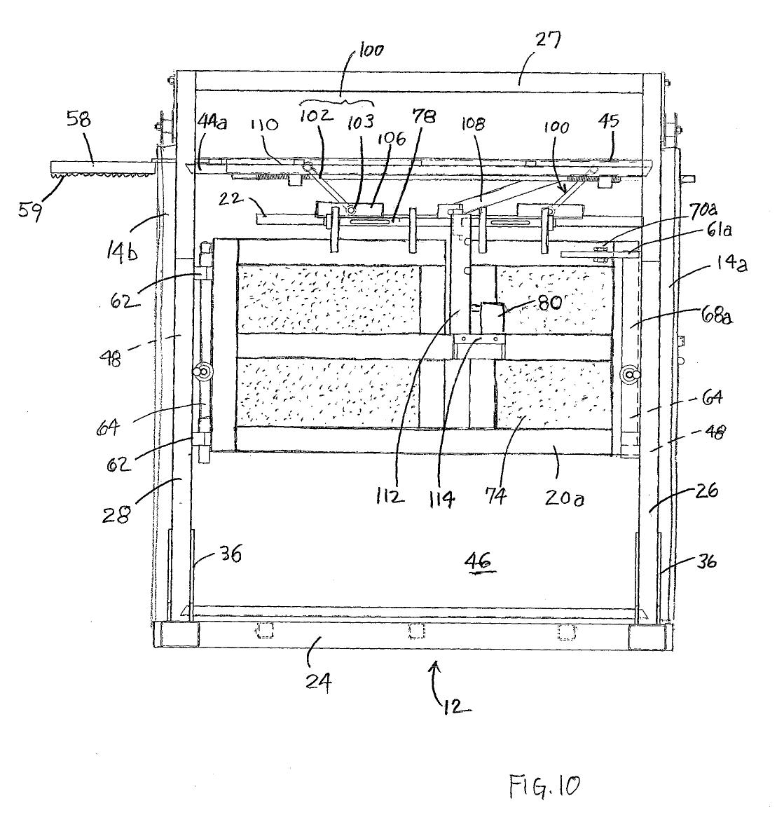

Referring to FIGS. 10-11, the two opposing side gates 20a, 20b of the apparatus 10 can be structured as hinged panel or corral gates that can be swung open to allow full access to the animal's flanks. The side gates 20a, 20b and gate locking mechanism 60 (side gate 20b) are constructed and fabricated to have sufficient strength to support the sides and weight of the animal against the side gates as the apparatus 10 is rotated. The side gates can be fabricated, for example, from ¼″×2″×4″ rectangular steel tubing/pipe.

The side gate hinges 62 can be mounted proximal to one of the rotatable inner circular frames 14a, 14b, for example, on a vertical rod 64 attached to an upright (vertical) pole 48.

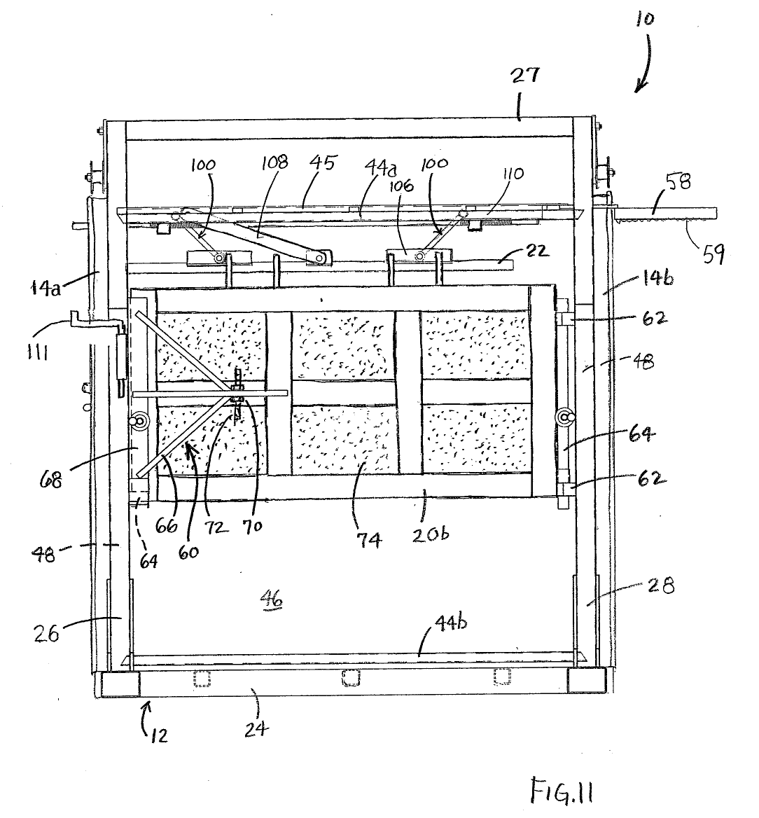

As shown in FIGS. 11 and 12, a locking mechanism 60 can be fabricated, for example, by welding three ⅞″ cold rolled (C. R.) round steel rods 66 to a hinged angled iron plate 68 mounted on a vertical rod 64 attached to an upright (vertical) pole 48. A bracket 70 (e.g., U-shaped bracket) sized to receive one of the round steel rods 66 of the locking mechanism 60 therein can be mounted (e.g., welded) on the side gate panel 20b. The U-shaped bracket 70 can include holes on opposite sides of the bracket through which a steel pin 72 (which can be attached to the side gate panel 20b) can be inserted to hold the round steel rod 66 of the locking mechanism 60 in place in the bracket 70.

As illustrated in FIG. 10, a locking mechanism for side gate 20a can be composed, for example, of a rod 61a mounted on a hinged angled iron plate 68a mounted on a vertical rod 64 attached to an upright (vertical) pole 48. A bracket 70a (e.g., U-shaped bracket) sized to receive the rod 61a therein can be mounted (e.g., welded) on the side gate panel 20a.

### Padding

The interior of the chute enclosure 46 can be padded all around to provide cushioning and support for the animal inside the apparatus. Padding 74 (e.g., about 1½″ thick) can be mounted on panels attached to the framework of the side gates 20a, 20b. The padding 74 can be fabricated, for example, from latex, wool, cotton, polyester, mattress padding, a foamed material such as a polyurethane foam (e.g., in an eggcrate style) or other material having memory that will return to its pre-compressed shape after being compressed.

### Belly Straps

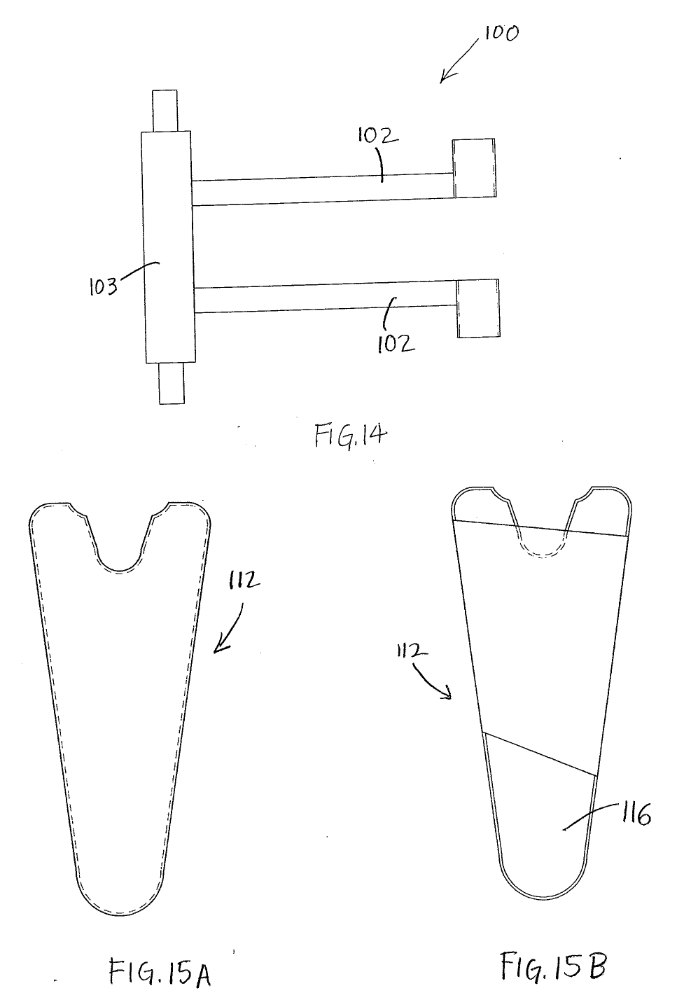

As shown in FIG. 2, the apparatus 10 further includes one or more belly straps 76, preferably a single full belly strap, for supporting the underside of the animal. As illustrated in FIGS. 2 and 10, one end of the belly strap 76 can be attached to a horizontal bar (not shown) mounted on the side door 20b. In use, the belly strap 76 is positioned under the belly of the animal and the free end is hooked to a strap 76a that is connected through slots 78a to another horizontal bar 78 mounted on the side door 20a. The horizontal bar 78 includes a sprocket 79 bearing a drive belt (roller chain) (not shown) connected to a sprocket of a motor 80, as shown in FIG. 10 (and in phantom in FIG. 3). The drive belt can be enclosed within a chain guard 112 as a safety feature, as further illustrated in FIG. 15A-15B. As depicted, the chain guard 112 includes an opening 116 through which the sprocket of the motor can be inserted. The motor 80 can be secured to a plate 114, which is mounted on the side gate 20a. In use, the bar 78 is turned to cinch the belly strap 76 tight about the animal to lift and hold the animal in place, and then reversed to loosen the belly strap to let the animal down.

### Leg Restraint Straps

Referring to FIGS. 1-2, leg restraint straps (not shown) can be mounted on a roller 81a of a mechanism 81 mounted on the side gate framework. As illustrated, the mechanism 81 is a cranking device that can be turned to cinch the leg restraint straps tight about the legs of the animal. In other embodiments, a motor with a forward/reverse switch can be utilized. Although only one mechanism 81 is shown on each side, typically two mechanisms 81, each bearing a leg restraint strap, are positioned on each side of the apparatus 10, one for restraining the front legs and another for restraining the back legs of the animal. The leg restraint straps can be composed, for example, of nylon straps constructed to be adjustable (e.g., using a Velcro® brand hook & loop tape), or other construction.

### Motor

As depicted in FIG. 3, the apparatus 10 can be powered by means of an electric motor 82, for example, a two horsepower (2HP) motor, with a 110 outlet plug 84 for connection of a motor control switch (not shown). The motor 82 can be mounted on top of the frame and connected to a gear box 86 composed, for example, of a pair of sprockets 88, 90, bearing a drive belt (roller chain) 92. The continuous drive (roller) chains 42a, 42b situated on the inner circular frames 14a, 14b can be mounted on sprockets 94a, 94b, respectively, which are mounted on opposite ends of an output shaft 96 connected to the sprocket 88 of the gear box 88. A cover 118 can be mounted on the apparatus 10 as illustrated in FIGS. 1-2.

Switching on the motor 82 triggers the rotation of the sprockets 88, 90 and the attached roller chain 92. This, in turn, actuates the rotation of the sprockets 94a, 94b and drive chains 42a, 42b and the rotation of the outer circular supports 26a, 26b of the apparatus. Rotation of the outer circular supports 26a, 26b can be geared down by the gear box to about 1 rpm.

### Moveable Ceiling Panel

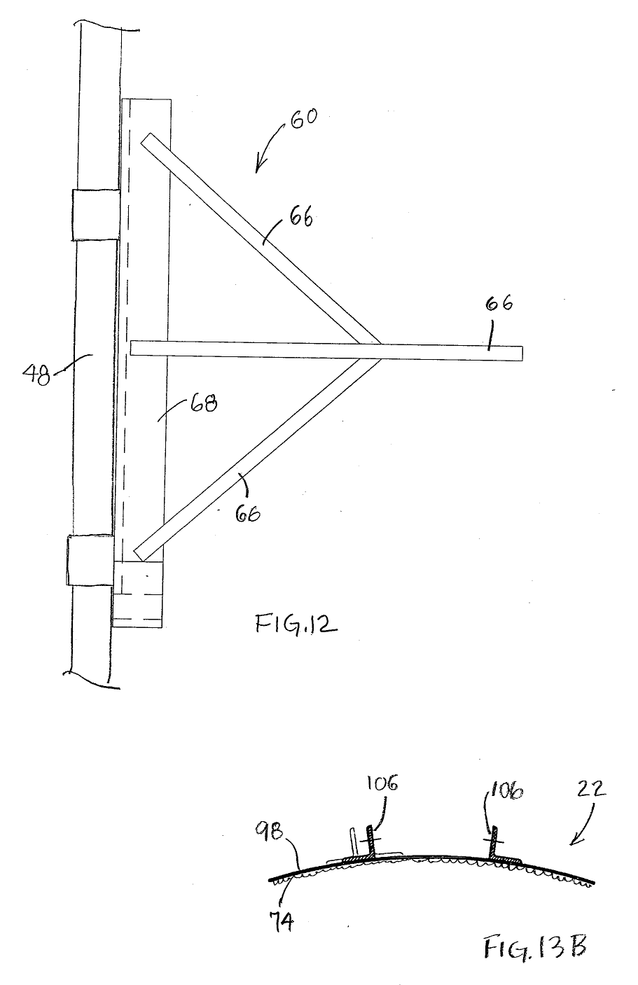

In preferred embodiments, a ceiling panel 22 can be structured to be mechanically movable in an upward and downward direction from the ceiling of the chute enclosure to within close proximity of or in contact with the back of an enclosed animal to provide support and help prevent injury to the animal's back during rotation of the apparatus 10, particularly during a 180° to 360° rotation. An embodiment of a retractable ceiling panel 22 is shown in FIGS. 3 and 10 in an extended position and in FIG. 4 in a retracted position. As shown and as further illustrated in FIGS. 13-13B, the ceiling panel 22 can be constructed as a curved elongate plate 98, which is attached by a connector 100 and an actuating arm 108 to an upper support plate or bracket 110 (FIGS. 3 and 10-11) that is mounted on the channel plate 45 (FIG. 6B). In the illustrated embodiment, the connector 100 is composed of rods 102 (e.g., about 8″ long) connected to a cross-rod 103 that fits into a C-channel 104 of a support plate 106 mounted on the ceiling panel 22. The actuating arm 108 mounted on the upper support plate 110 can be connected to an actuating mechanism 111 such as a crank, hydraulic connection, motor and electronic mechanism, etc., that can be activated to move the actuating arm 108 and the cross-rod 103 of the connector 100 along the C-channel 104 causing the rods 102 and curved elongate plate 98 to swing downward (e.g., about 8″) from the upper support plate 110 to position the curved elongate plate 98 within contact or close proximity of the back of an animal within the chute enclosure 46. The actuating mechanism 111 can then be activated to move the actuating arm 108 upward and the cross rods 103 along the C-channel 104 in a reverse direction to move the rods 102 and curved elongate plate 98 upwardly to within close proximity (e.g., about ½″) to the upper support plate 110. In preferred embodiments, the ceiling panel 22 includes padding 74.

### Use of Apparatus

In use, the forward gates 16a, 16b can be swung inwardly into the interior chute enclosure 46, and the animal then corralled into the chute enclosure through one of the open accessible gates such that the animal is facing toward the exit (outlet) 52. For example, the animal can be corralled through the rear gates 18a, 18b with the side gates 20a, 20b closed/locked, or through one of the side gates with the rear gates 18a, 18b and the other of the side gates closed/locked.

The animal is moved into the chute enclosure and runs into the forward gate units 16a, 16b, whereby the contact of the ‘shoulders’ of the animal force the gate units 16a, 16b forward and into a locking position within the locking mechanism 56b, with the animal's neck and head extending through the gap 57 between the forward gates units 16a, 16b, and restricted in its fore and aft movement. The open gate (e.g., the rear gate 18a, 18b) can then be closed and locked behind the animal.

With the animal within the enclosure, the belly strap 76 can then be positioned under the belly of the animal and attached to the small strap 76a, and the motor 80 can then be actuated to position the animal as desired within the chute. Leg restraint straps (not shown) can also be attached around the legs of the animal and tightened. In addition, where included, the moveable ceiling panel 22 can then be actuated downward close to or in contact with the animals' back to further secure the animal in place within the enclosure.

With the animal secured within the chute enclosure 46, the motor 82 can then be switched on, causing movement of sprockets 88, 90 and the attached roller chain 92 which, in turn, actuates rotation of the sprockets 94a, 94b and attached drive chains 42a, 42b and the rotation of the inner circular frames 14a, 14b of the apparatus through a full 360° angle rotation or a position in between.

For example, the inner circular frames 14a, 14b of the apparatus 10 can be rotated 180° to invert or turn the animal upside down from an upright (standing) position and expose the animal's belly. In this position, a veterinarian or other animal specialist can perform surgeries and other procedures such as to correct a twisted stomach, artificial insemination (A. I.), etc. In another application, the inner circular frames 14a, 14b of the apparatus 10 can be rolled/rotated to position the animal at an about 90° angle to expose the animal's hooves for a trimming procedure. When completed, the motor can again be actuated to further rotate the outer circular supports such that the animal is returned to an upright position.

Upon completion of the desired operation or other procedure, the movable ceiling panel 22 (if used) can be moved upward out of contact with the animal, the motor 80 can be actuated to loosen the belly strap 76 and lower the animal, the leg restraints can be detached, and the forward gates 16a, 16b unlatched to allow the animal to exit (52) the apparatus 10.

Advantages.

The present apparatus is lightweight, mobile, easy to use and requires no hydraulics or hard wiring. The apparatus can be used for typical farm procedures such hoof trimming, vaccinations, artificial insemination (A. I.) breeding, etc., and is most advantageous for simplifying ‘Roll and Tac’ procedures applied to correct displaced abdomen (twisted stomach) in cattle and other ruminants.

The apparatus allows the animal to enter from any of the four gate openings. Additionally, the interior of the enclosure is accessible through any of the gates such that all sides of the animal can be reached while immobilized in the chute enclosure to perform a desired activity or procedure. The apparatus also allows quick release of the animal in a forward or ‘head first’ direction at the conclusion of a procedure.

The apparatus is constructed to provide a chute enclosure that is suitable for use with substantially all sizes of animals, and does not utilize a squeezable chute enclosure which can cause injury to the animal. Adjustments to accommodate the size of the animal within the chute enclosure can be made by the positioning of a moveable ceiling plate relative to the animal's back and adjusting the tightness of the belly strap(s) around the animal.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations that operate according to the principles of the invention as described. Therefore, it is intended that this invention be limited only by the claims and the equivalents thereof. The disclosures of patents, references and publications cited in the application are incorporated by reference herein.

What is claimed is:

1. An apparatus for inverting an animal from an upright position, comprising:
a stationary frame comprising a base platform;
a pair of rotatable circular frames mounted at opposing ends of the base platform of the stationary frame;
a forward gate, a rear gate and opposing side gates mounted on the base platform and defining boundaries of a chute enclosure extending from the forward gate to the rear gate;
a mechanism connected to the rotatable circular frames operable for rotating the circular frames in a 360° rotation.

2. The apparatus of claim 1, further comprising a ceiling panel that is moveable in a vertical direction to contact an animal positioned within the chute enclosure.

3. The apparatus of claim 1, wherein an animal positioned within the chute enclosure is immobilized without mechanical movement of the side gates or side panels/walls to squeeze or put pressure on the animal.

4. The apparatus of claim 1, wherein the apparatus is not operable to squeeze the sides of an animal positioned within the chute enclosure.
